(19) United States
(12) Patent Application Publication
(10) Pub. No.: US 2026/0131640 A1
(43) Pub. Date: May 14, 2026

(54) MINIATURE ELECTRIC ACTUATOR FOR HIGH-INTEGRATION VEHICLE SUNSHADE ROLLER BLIND

(71) Applicant: Fuyao University of Science and Technology, Fuzhou City (CN)

(72) Inventors: Hongxing WU, Fuzhou City (CN); Weiming SHEN, Fuzhou City (CN); Hui YOU, Fuzhou City (CN); Peng GAO, Fuzhou City (CN); Xianping LIU, Fuzhou City (CN); Yue WU, Fuzhou City (CN); Wei SHEN, Fuzhou City (CN); Kaifang ZHOU, Fuzhou City (CN); Zhimiao RAO, Fuzhou City (CN)

(73) Assignee: Fuyao University of Science and Technology, Fuzhou City (CN)

(21) Appl. No.: 19/351,992

(22) Filed: Oct. 7, 2025

(30) Foreign Application Priority Data
Nov. 13, 2024 (CN) 202411615061.9

(51) Int. Cl. B60J 3/02; F16H 1/46

(52) U.S. Cl. CPC B60J 3/02; F16H 1/46

(57) ABSTRACT

A miniature electric actuator for a high-integration vehicle sunshade roller blind is provided and relates to the technical field of sunshade roller blinds for vehicles. The technical features of the technical solution thereof are as follows: the electric actuator includes a driving motor (1), a roller blind synchronizing wheel (3) and a roller blind tube (5). A planetary reducer (2) is connected with an output end of the driving motor (1). The planetary reducer (2) is integrated inside the roller blind synchronizing wheel (3). A roller blind synchronizing inner tube (4) is fixedly connected with the output end of the planetary reducer (2). The roller blind synchronizing inner tube (4) is rotatably connected with the roller blind tube (5) by means of a bearing. A pre-tensioning spring (6) is disposed between the roller blind synchronizing inner tube (4) and the roller blind tube (5).

### CROSS-REFERENCE TO RELATED APPLICATION

This patent application claims the benefit and priority of Chinese Patent Application No. 202411615061.9, entitled “MINIATURE ELECTRIC ACTUATOR FOR HIGH-INTEGRATION VEHICLE SUNSHADE ROLLER BLIND” filed on Nov. 13, 2024, the disclosure of which is incorporated by reference herein in its entirety as part of the present application.

### TECHNICAL FIELD

The present disclosure relates to the technical field of sunshade roller blinds for vehicles, and in particular to a miniature electric actuator for a high-integration vehicle sunshade roller blind.

### BACKGROUND

The existing electric actuator for the vehicle sunshade roller blind is provided with a speed reducer disposed externally and generally adopts a deceleration method based on a gear and lead screw, an electric motor and a reel are mounted parallelly or vertically, but such a conventional device has the defects of low deceleration efficiency, small transmission torque and the like. Also, the electric motor and the speed reducer of the conventional device are mounted on an outer side of the roller blind, substantially reducing the area of the vehicle sunroof, and this device is not conducive to meeting the requirement for maximized lighting of the vehicle sunshade,

In view of this, the inventors provide a miniature electric actuator for a high-integration vehicle sunshade roller blind.

### SUMMARY

The embodiments aim to provide a miniature electric actuator for a high-integration vehicle sunshade roller blind to solve the above problems.

The objective of the present disclosure is achieved by the following technical solution. The miniature electric actuator for the high-integration vehicle sunshade roller blind includes a driving motor, a roller blind synchronizing wheel and a roller blind tube. A planetary reducer is connected with an output end of the driving motor. The planetary reducer is integrated inside the roller blind synchronizing wheel. A roller blind synchronizing inner tube is fixedly connected with an output end of the planetary reducer. The roller blind synchronizing inner tube is rotatably connected with the roller blind tube by means of a bearing. Pre-tensioning springs are disposed between the roller blind synchronizing inner tube and the roller blind tube.

A further configuration of the present disclosure is as follows. The planetary reducer includes a primary planetary assembly. The primary planetary assembly is fixedly connected with the output end of the driving motor. A secondary planetary assembly is connected with an end, away from the driving motor, of the primary planetary assembly. The secondary planetary assembly is connected with the roller blind synchronizing wheel.

A further configuration of the present disclosure is as follows. The primary planetary assembly includes a primary sun wheel and a planetary reducer primary outer gear ring. The primary sun wheel is fixedly connected with the output shaft of the driving motor. The primary sun wheel is in meshed connection with three primary planetary gears. A primary gear carrier is rotatably connected with the three primary planetary gears by means of bearings. A primary planetary output shaft is connected with an end, away from the driving motor, of the primary gear carrier. Primary planetary fixing outer ring teeth are disposed on an inner side of the planetary reducer primary outer gear ring. The primary planetary fixing outer ring teeth are in meshed connection with the primary planetary gear. The planetary reducer primary outer gear ring is fixedly connected with the driving motor. The planetary reducer primary outer gear ring is rotatably connected with the primary planetary output shaft by means of a bearing.

A further configuration of the present disclosure is as follows. The secondary planetary assembly includes a secondary sun wheel. The secondary sun wheel is fixedly connected with the primary planetary output shaft. The secondary sun wheel is in meshed connection with three secondary planetary gears. The secondary planetary gear is in meshed connection with a secondary reducer gear ring. An outer rotor output shaft is connected with the secondary reducer gear ring. Secondary planetary outer rotor outer ring teeth are disposed on an inner side of the outer rotor output shaft. The outer rotor output shaft is rotatably connected with the primary planetary assembly by means of a bearing. The outer rotor output shaft is fixedly connected with the roller blind synchronizing wheel. The outer rotor output shaft is fixedly connected with the roller blind synchronizing inner tube.

A further configuration of the present disclosure is as follows. Primary planetary gear carrier retaining screws are further included. The planetary reducer primary outer gear ring is fixedly connected with the driving motor by means of the primary planetary gear carrier retaining screws.

A further configuration of the present disclosure is as follows. Roller blind synchronizing inner tube retaining screws are further included. The outer rotor output shaft is fixedly connected with the roller blind synchronizing inner tube by means of the roller blind synchronizing inner tube retaining screws.

In summary, the embodiments have the following beneficial effects. The high integration level and miniaturization of the actuator are achieved by integrating the planetary reducer inside the vehicle roller blind synchronizing wheel. The planetary reducer adopts a hybrid structure including an inner rotor output shaft and the outer rotor output shaft. The planetary reducer outputs a torque directly to a power output of the vehicle roller blind synchronizing wheel in a limited space, and the output of the planetary reducer is simultaneously connected with a vehicle roller blind synchronizing inner tube, such that a large torque is output to the vehicle roller blind synchronizing inner tube after deceleration, and the torque is transmitted to the other side of a vehicle sunshade roller blind shaft by means of the vehicle roller blind synchronizing inner tube, achieving the torque balance of this shaft. Two ends of the pre-tensioning spring between a roller blind reel and the roller blind synchronizing inner tube are respectively connected with the roller blind reel and the roller blind synchronizing inner tube, to provide a pre-tensioning force of the roller blind reel. The embodiments are simple in structure, high in integration level and low in cost, can be used in occasions such as electric sunshade roller blind systems, robots, electric tools, drones and the like of fuel vehicles and electric vehicles, and have good application prospects.

### BRIEF DESCRIPTION OF THE DRAWINGS

FIG. 1 is a first structural schematic diagram of a miniature electric actuator for a high-integration vehicle sunshade roller blind according to an embodiment of the present disclosure;

FIG. 2 is a second structural schematic diagram of the miniature electric actuator for the high-integration vehicle sunshade roller blind according to the embodiment of the present disclosure;

FIG. 3 is a third structural schematic diagram of the miniature electric actuator for the high-integration vehicle sunshade roller blind according to the embodiment of the present disclosure according to an embodiment of the present disclosure.

List of the reference characters: 1 driving motor; 2 planetary reducer; 3 roller blind synchronizing wheel; 4 roller blind synchronizing inner tube; 5 roller blind tube; 6 pre-tensioning spring; 7 primary planetary gear carrier retaining screw; 8 roller blind synchronizing inner tube retaining screw; 21 primary planetary assembly; 22 secondary planetary assembly; 211 primary sun wheel; 212 primary planetary gear; 213 primary gear carrier; 214 primary planetary output shaft; 215 planetary reducer primary outer gear ring; 216 primary planetary fixing outer ring teeth; 221 secondary sun wheel; 222 secondary planetary gear; 223 outer rotor output shaft; 224 secondary reducer gear ring.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the embodiments described are merely some rather than all of the embodiments of the present disclosure. On the basis of the embodiments of the present disclosure, all other embodiments that can be obtained by those of ordinary skill in the art without creative efforts shall fall within the scope of protection of the present disclosure.

### Embodiment

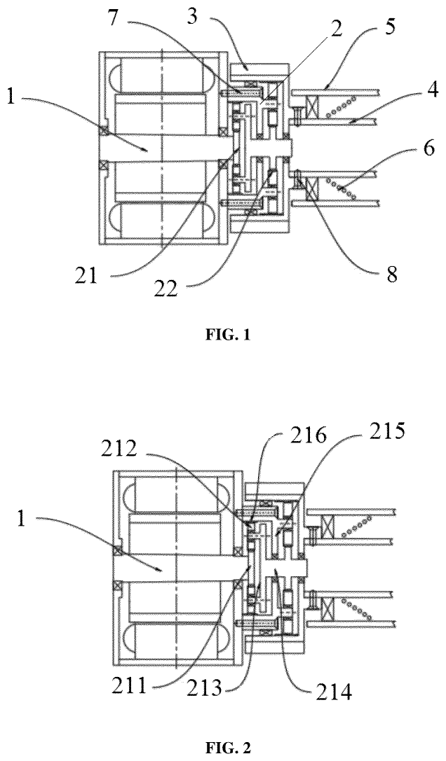

A miniature electric actuator for a high-integration vehicle sunshade roller blind, as shown in FIG. 1, includes a driving motor 1, a roller blind synchronizing wheel 3 and a roller blind tube 5. A planetary reducer 2 is connected with an output end of the driving motor 1. The planetary reducer 2 is integrated inside the roller blind synchronizing wheel 3. A roller blind synchronizing inner tube 4 is fixedly connected with the output end of the planetary reducer 2. The roller blind synchronizing inner tube 4 is rotatably connected with the roller blind tube 5 by means of a bearing. Pre-tensioning springs 6 are disposed between the roller blind synchronizing inner tube 4 and the roller blind tube 5.

In this embodiment, the planetary reducer 2 includes a primary planetary assembly 21. The primary planetary assembly 21 is fixedly connected with the output end of the driving motor 1. A secondary planetary assembly 22 is disposed at an end, away from the driving motor 1, of the primary planetary assembly 21, and the secondary planetary assembly 22 is fixedly connected with the roller blind synchronizing wheel 3.

In this embodiment, as shown in FIG. 2, the primary planetary assembly 21 includes a primary sun wheel 211 and a planetary reducer primary outer gear ring 215. The primary sun wheel 211 is fixedly connected with the output shaft of the driving motor 1. The primary sun wheel 211 is in meshed connection with three primary planetary gears 212. A primary gear carrier 213 is rotatably connected with the primary planetary gears 212 by means of bearings. A primary planetary output shaft 214 is connected with an end of the primary gear carrier 213 remote from the driving motor 1. Primary planetary fixing outer ring teeth 216 are disposed on an inner side of the planetary reducer primary outer gear ring 215. The primary planetary fixing outer ring teeth 216 are in meshed connection with the primary planetary gear 212. The planetary reducer primary outer gear ring 215 is fixedly connected with the driving motor 1. The planetary reducer primary outer gear ring 215 is rotatably connected with the primary planetary output shaft 214 by means of a bearing.

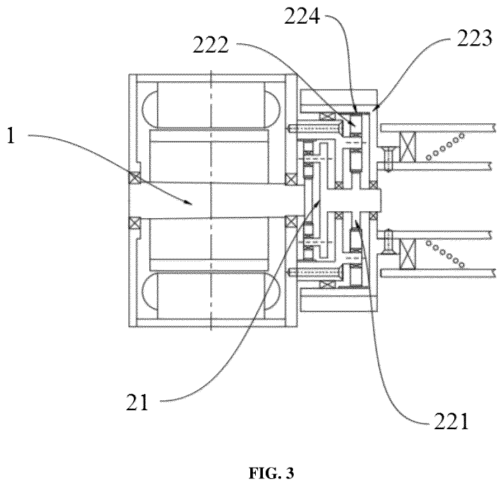

In this embodiment, as shown in FIG. 3, the secondary planetary assembly 22 includes a secondary sun wheel 221. The secondary sun wheel 221 is fixedly connected with the primary planetary output shaft 214. The secondary sun wheel 221 is in meshed connection with a secondary planetary gear 222. The secondary planetary gear 222 is in meshed connection with an outer rotor output shaft 223. Secondary planetary outer rotor outer ring teeth are disposed on an inner side of the outer rotor output shaft 223. The outer rotor output shaft 223 is rotatably connected with the primary planetary assembly 21 by means of a bearing. The outer rotor output shaft 223 is fixedly connected with the roller blind synchronizing wheel 3. The outer rotor output shaft 223 is fixedly connected with the roller blind synchronizing inner tube 4.

In this embodiment, primary planetary gear carrier retaining screws 7 are further included, and the primary outer gear ring is fixedly connected with the driving motor 1 by means of the primary planetary gear carrier retaining screws 7.

In this embodiment, roller blind synchronizing inner tube retaining screws 8 are further included, and the outer rotor output shaft 223 is fixedly connected with the roller blind synchronizing inner tube 4 by means of the roller blind synchronizing inner tube retaining screws 8.

Operation principle is as follow.

The driving motor 1 includes a motor housing, a front motor end cover and a rear motor end cover, a motor stator core, a motor rotor core, a motor stator winding, a motor rotor permanent magnet and a motor output shaft. The motor stator core has a tooth groove structure, and a motor winding is wound around the tooth groove structure. The operation principle is on the basis of the law of electromagnetic induction. When a stator winding is energized, a rotating magnetic field is generated and interacts with a permanent magnet magnetic field of a rotor to generate a torque, thereby causing the rotor to rotate.

A vehicle sunshade roller blind system includes the roller blind synchronizing wheel 3, the fabric roller blind reel, the roller blind synchronizing inner tube 4 and the pre-tensioning springs 6 between the fabric roller blind reel and the roller blind synchronizing inner tube. The synchronizing wheel is provided with a synchronous belt for driving a fabric roller blind body to extend and retract. The synchronizing wheel and the roller blind synchronizing inner tube are an integrated member, the roller blind synchronizing inner tube transmits a driving torque to the other side of the roller blind to achieve a torque balance of two sides of the roller blind. Two ends of the pre-tensioning spring 6 between the fabric roller blind reel and the roller blind synchronizing inner tube are respectively connected with the fabric roller blind reel and the roller blind synchronizing inner tube, and a pre-tensioning force of the pre-tensioning spring 6 allows the fabric roller blind to have an enough force to tension the fabric roller blind.

The torque transmission between the output shaft of the driving motor 1 and the roller blind synchronizing wheel 3 is performed by adopting the secondary planetary reducer 2, the primary sun wheel 211 of the planetary reducer 2 is mounted on the rotor output shaft of the driving motor 1 and is connected by adopting a D-shaped shaft hole. The driving motor 1 drives the primary sun wheel 211 to rotate by means of a motor rotor shaft, the primary sun wheel 211 drives the primary planetary gears 212 to rotate, the primary planetary gears 212 are meshed with the primary reducer outer gear ring, the primary reducer outer gear ring is fixedly connected with the stator front end cover of the driving motor 1, and the primary planetary gear rotates around the primary sun wheel 211. The primary planetary gear carrier is connected with the primary planetary gear shaft by means of an oil bearing. The rotation of the primary planetary gear around the primary sun wheel 211 drives the primary planetary gear carrier to rotate, outputting a primary planetary reduction torque.

The secondary sun wheel 221 of the planetary reducer 2 is mounted on the primary planetary output shaft 214 and is connected by means of a D-shaped shaft hole. The primary planetary output shaft 214 drives the secondary planetary sun wheel to rotate, the secondary planetary sun wheel drives the secondary planetary gears 222 to rotate, the secondary planetary gears 222 are meshed with a secondary reducer gear ring 224, the secondary reducer gear ring 224 is connected with the output shaft, a secondary reducer inner gear ring is fixedly connected with the roller blind system synchronizing wheel, and a side of the secondary reducer inner gear ring is similarly fixedly connected with the roller blind synchronizing inner tube 4. Since the primary planetary gear carrier is a fixed member, the secondary planetary gear rotates along with the secondary sun wheel 221, and the secondary planetary gear shaft and the primary planetary gear carrier remains unchanged in position. The secondary planetary gear is meshed with the secondary reducer inner gear ring to cause the secondary reducer inner gear ring to perform a decelerating rotational movement.

The secondary reducer inner gear ring is fixedly connected with the roller blind system synchronizing wheel, and the side of the secondary reducer inner gear ring is similarly fixedly connected with the roller blind synchronizing inner tube 4. When the torque output by the driving motor 1 passes through the secondary reducer, the torque thereof is transmitted to the roller blind system synchronizing wheel and the roller blind synchronizing inner tube 4, and the roller blind system synchronizing wheel and the roller blind synchronizing inner tube 4 output the torque and a synchronous rotational speed simultaneously.

The pre-tensioning springs 6 are connected between the fabric roller blind reel and the roller blind synchronizing inner tube 4, and the two ends of the tensioning spring are respectively connected with the fabric roller blind reel and the roller blind synchronizing inner tube 4. In order to ensure the relative sliding between the fabric roller blind reel and the roller blind synchronizing inner tube 4, the bearing is mounted therebetween. The rotational movement of the roller blind synchronizing inner tube 4 drives the fabric roller blind by means of the pre-tensioning springs 6, and due to the presence of the pre-tensioning springs 6, the fabric roller blind body of the sunshade roller blind is always in a tensioned state, such that the electric sunshade roller blind system can operate normally.

It should be finally noted that the above descriptions are only preferred embodiments of the present disclosure and are not intended to limit the present disclosure. Although the present disclosure has been described in detail with reference to the foregoing embodiments, for those skilled in the art, the technical solutions described in the foregoing embodiments may still be modified or some technical features therein may be equivalently replaced. Any modifications, equivalent substitutions, improvements, etc. made within the spirit and principles of the present disclosure shall fall within the scope of protection of the present disclosure.

What is claimed is:

1. A miniature electric actuator for a high-integration vehicle sunshade roller blind, comprising a driving motor (1), a roller blind synchronizing wheel (3) and a roller blind reel (5), wherein a planetary reducer (2) is connected with an output end of the driving motor (1), the planetary reducer (2) is integrated inside the roller blind synchronizing wheel (3), a roller blind synchronizing inner tube (4) is fixedly connected with an output end of the planetary reducer (2), the roller blind synchronizing inner tube (4) is rotatably connected with the roller blind reel (5) by means of a bearing, and pre-tensioning springs (6) are disposed between the roller blind synchronizing inner tube (4) and the roller blind reel (5).

2. The miniature electric actuator for the high-integration vehicle sunshade roller blind according to claim 1, wherein the planetary reducer (2) comprises a primary planetary assembly (21), the primary planetary assembly (21) is connected with the output end of the driving motor (1), a secondary planetary assembly (22) is disposed at an end, away from the driving motor (1), of the primary planetary assembly (21), and the secondary planetary assembly (22) is connected with the roller blind synchronizing wheel (3).

3. The miniature electric actuator for the high-integration vehicle sunshade roller blind according to claim 2, wherein the primary planetary assembly (21) comprises a primary sun wheel (211) and a planetary reducer primary outer gear ring (215), the primary sun wheel (211) is fixedly connected with the output shaft of the driving motor (1), the primary sun wheel (211) is in meshed connection with three primary planetary gears (212), a primary gear carrier (213) is rotatably connected with the three primary planetary gears (212) by means of bearings, a primary planetary output shaft (214) is connected with an end, away from the driving motor (1), of the primary gear carrier (213), primary planetary fixing outer ring teeth (216) are disposed on an inner side of the planetary reducer primary outer gear ring (215), the primary planetary fixing outer ring teeth (216) are in meshed connection with the primary planetary gear (212), the planetary reducer primary outer gear ring (215) is fixedly connected with the driving motor (1), and the planetary reducer primary outer gear ring (215) is rotatably connected with the primary planetary output shaft (214) by means of a bearing.

4. The miniature electric actuator for the high-integration vehicle sunshade roller blind according to claim 2, wherein the secondary planetary assembly (22) comprises a secondary sun wheel (221), the secondary sun wheel (221) is fixedly connected with the primary planetary output shaft (214), the secondary sun wheel (221) is in meshed connection with three secondary planetary gears (222), the secondary planetary gear (222) is in meshed connection with a secondary reducer gear ring (224), an outer rotor output shaft (223) is connected with the secondary reducer gear ring

(224) secondary planetary outer rotor outer ring teeth are disposed on an inner side of the outer rotor output shaft (223), the outer rotor output shaft (223) is rotatably connected with the primary planetary assembly (21) by means of a bearing, the outer rotor output shaft (223) is fixedly connected with the roller blind synchronizing wheel (3), and the outer rotor output shaft (223) is fixedly connected with the roller blind synchronizing inner tube (4).

5. The miniature electric actuator for the high-integration vehicle sunshade roller blind according to claim 3, further comprising primary planetary gear carrier retaining screws (7), wherein the planetary reducer primary outer gear ring is fixedly connected with the driving motor (1) by means of the primary planetary gear carrier retaining screws (7).

6. The miniature electric actuator for the high-integration vehicle sunshade roller blind according to claim 4, further comprising roller blind synchronizing inner tube retaining screws (8), wherein the outer rotor output shaft (223) is fixedly connected with the roller blind synchronizing inner tube (4) by means of the roller blind synchronizing inner tube retaining screws (8).
